(19) United States
(12) Patent Application Publication
(10) Pub. No.: US 2011/0189081 A1
(43) Pub. Date: Aug. 4, 2011

(54) CRYSTALLINE INORGANIC SPECIES HAVING OPTIMISED REACTIVITY

(76) Inventors: Gao Qing Lu, Mt. Ommaney (AU); Shizhang Qiao, Kenmore (AU); Huagui Yang, Shanghai (CN)

(21) Appl. No.: 12/934,445

(22) PCT Filed: Mar. 25, 2009
(86) PCT No.: PCT/AU2009/000340

§ 371 Date: Dec. 8, 2010

(30) Foreign Application Priority Data
Mar. 25, 2008 (AU) 2008901423

(51) Int. Cl. C01G 23/047; B82Y 30/00

(52) U.S. Cl. 423/612; 423/610; 977/755

(57) ABSTRACT

A method for synthesizing high quality crystalline anatase titanium dioxide having a substantial occurrence of (001) facets. Including the steps of combining a source of fluoride anions with a titanium precursor and subjecting the mixture to hydrolysis. A solvent can be combined with the source of fluoride anions and the titanium precursor prior to hydrolysis. The crystalline anatase titanium dioxide can be produced to have the highly reactive (001) facets predominant by area in a variety of crystal structures, such as nanosheets.

### TECHNICAL FIELD

The invention relates to high quality, reactive crystalline inorganic species, preferably an inorganic oxide such as high quality crystalline anatase TiO₂ having a substantial occurrence of {001} facets. The invention further provides a method for synthesizing high quality, reactive crystalline inorganic species such as high quality anatase TiO₂ using a source of adsorbate anions as a morphology controlling agent.

### BACKGROUND

In this specification where a document, act or item of knowledge is referred to or discussed, this reference or discussion is not an admission that the document, act or item of knowledge or any combination thereof was at the priority date, publicly available, known to the public, part of common general knowledge; or known to be relevant to an attempt to solve any problem with which this specification is concerned.

While examples of the present invention will be described with reference to single crystals having highly reactive crystal facets the present invention is not so limited but more broadly includes other crystalline forms including clusters or aggregates, tubes, films, sheets or rods with highly reactive crystal facets. Furthermore, while examples of the present invention will be described principally with reference to TiO₂, the crystalline forms of other metal oxides, such as ZnO, SnO₂, CO₃O₄, CuO, etc., also can be generated with well-defined crystallographic facets using the same methodology as disclosed in this specification.

### Inorganic Single Crystals

Inorganic single crystals (SCs) are crystalline solids in which the crystal lattice is continuous and unbroken to the edges of the solid, with no grain boundaries.

SCs of meaningful size are exceedingly rare in nature. But due to their scientific and technological importance, SCs with highly reactive surfaces are valuable and successful synthetic routes have long been targeted in the laboratory.

However, to be of use SCs must be free of features which impose undesirably entropic effects such as impurities, crystallographic defect and dislocations. They must also have suitably reactive surfaces. The surface stability and reactivity of SCs have long been thought to be dominated by their surface chemistry. The effect of the surface chemistry on the equilibrium morphology of the crystal is critical for the synthesis of SCs with high reactivity. Unfortunately, surfaces with high reactivity usually diminish rapidly during the crystal growth process due to minimization of surface energy.

### Anatase Titanium Dioxide

Anatase is one of the four forms of TiO₂ found in nature (the others being rutile, brookite and TiO₂ II).

Anatase TiO₂ has promising potential for application in a wide variety of fields, including photovoltaic cells, photo- and electro-chromics, photocatalysis, photonic crystals, smart surface coatings and sensors. Anatase TiO₂ SCs are dominated by the thermodynamically stable {101} facets (more than 94% according to Wulff construction as described at Lazzeri et al, Phys. Rev. B 63, 155409 (2001)), as opposed to the much more reactive {001} facets.

For anatase TiO₂, both theoretical and experimental studies indicate that its minority {001} facets are much more reactive than the thermodynamically stable {101} facets, even though in the equilibrium state, both natural and synthetic anatase crystals are usually dominated by the less reactive {101} facets. Numerous synthetic methods have been attempted, such as those described by Chen et al, Chem. Rev. 107 (2007) 2891-2959; Izumi, Bull. Chem. Soc. Jpn. 51 (1978) 1771-1776; and Berger et al, J. Cryst. Growth 130 (1993) 108-112. However, it has not been possible to prepare large high-quality anatase SCs with a high percentage of {001} facets.

An early investigation by Izumi et al (Bull. Chem. Soc. Jpn. 51 (1978) 1771-1776) indicated that the hydrothermal treatment of hydrous titanium (IV) oxide in the presence of HF could produce polymorphic crystals of TiO₂ with an irregular shape. The anhedral morphology and rough surface of irregular aggregates mainly resulted from a high supersaturation.

Meanwhile, the function of fluoride anions with respect to anatase crystal growth is not clear and there are no known theoretical studies that have explored the effects of fluoride on the isotropic growth process. Recently, anatase TiO₂ films with {001} crystallographic facets and anatase SCs have been achieved by metal-organic chemical vapour deposition (MOCVD) or chemical transport reactions, but such processes have the limitations of relatively low purity (1.5 at. %) and long reaction time (20-30 days)(as reported by Herman et al, Phys. Rev. Lett. 84 (2000) 3354-3357 and Berger et al, J. Cryst. Growth 130 (1993) 108-112).

Previous experimental and theoretical studies have indicated that absorbate atoms can effectively change the relative stabilities of different crystal facets. For anatase TiO₂, among oxygenated surfaces, the (100) surface is the most stable, rather than the (101) surface, in clean and hydrogenated conditions. However, both H- and O-terminated anatase surfaces present high surface energies (y), which restrict the formation of large single-crystal anatase.

Compared with the advances in rutile TiO₂ SCs over the past decade, surface science investigations of anatase TiO₂ facets are scarce, largely due to the difficulty of growing well defined SCs.

As a consequence, preparation of uniform and high-purity anatase with precisely controlled crystallographic facets still remains a challenge and is of great importance for various practical applications as well as fundamental surface science studies.

### BRIEF SUMMARY

The present invention provides high quality inorganic crystalline material with reactive crystalline facets. In particular the present invention provides high quality inorganic oxide material having a substantial occurrence, or predominantly, reactive crystalline facets.

In a broad form there are provided forms of crystalline anatase TiO₂ having a substantial occurrence of {001} facets. In particular example embodiments the {001} facets are predominant.

In various forms, the crystalline anatase TiO₂ is: a single crystal structure; an aggregate or cluster of crystals; a polycrystalline or paracrystalline structure, the {001} facets formed in crystallites of the structure; and/or a nanosheet(s) structure.

In a broad form, there is provided a method for synthesizing crystalline anatase TiO₂ having a substantial occurrence of {001} facets, the method comprising the steps of: combining a source of fluoride anions with a titanium precursor; and subjecting the mixture to hydrolysis.

Reference to a “substantial occurrence” of {001} facets should be read as implying that the {001} facets provide 20% or more of the surface area of a crystal, crystallite, cluster or aggregate of crystals, polycrystalline or paracrystalline structure, or nanosheet(s). Reference to {001} facets being “predominant” should be read as implying that the {001} facets provide 50% or more of the surface area. Moreover, by optimising reaction conditions, the {001} facets could provide 80% or more of the surface area; and it is expected that up to about 90%, or potentially higher, of the surface area being provided by {001} facets is achievable.

Preferably there may be further included the step of combining a solvent with the source of fluoride anions and the titanium precursor, prior to hydrolysis.

Optionally the high quality inorganic crystalline material, such as crystalline anatase TiO₂, is in the form of SCs, tubes, films, sheets and/or rods.

When SCs are formed, the SCs may be used as “bottom-up” building blocks to generate two-dimensional arrays or three-dimensional stacking architectures on substrates by a self-assembly process. These or other crystalline structures can have applications in photonics, large scale integrated TiO₂ solar cells or water cleavage devices, and high purity model crystals for surface science studies (for example, the reconstruction of stoichiometric surfaces).

In another broad form, there is further provided a method for synthesizing high quality crystalline anatase TiO₂ with predominantly {001} facets, the method comprising the steps of: combining a solvent and a source of fluoride anions with a titanium precursor; and subjecting the mixture to hydrolysis.

Optionally the solvents are polar alcohols, such as n-propanol or ethanol. The solvent may also be selected from the group consisting of n-propanol, ethanol, 1-butanol, isobutanol, water, a solution of an acid, a solution of hydrochloric acid, a solution of hydrofluoric acid, and mixtures thereof.

Preferably the source of fluoride anions are from HF or fluoride salts such as NaF, KF, NH₄F, etc. An aqueous solution of HF may also act as a solvent.

Preferably the titanium precursor is a titanium salt such as TiF₄, TiCl₄, or TTIP, and/or tetrabutyl titanate (Ti(OBu)₄).

Typically the hydrolysis is forced hydrolysis, carried out by autoclaving. The autoclaving may be carried out at relatively low temperature, for example from 170 to 220° C., more preferably 180° C. The optimal time for hydrolysis will depend on a number of parameters, principally the temperature used. Typically the hydrolysis would be carried out for between 5 and 50 hours.

The method provides fluoride-terminated surfaces such that the (001) surfaces of the crystalline structure are energetically preferable to (101), a reverse of the stability observed in the prior art. The optimised method has been established through the use of theory based on first-principle quantum chemical calculations for a range of non-metallic atoms (H, B, C, N, O, F, Si, P, S, Cl, Br, I). Fluorine has the greatest morphology controlling effect with respect to the synthesis of uniform anatase TiO₂ crystals with a high percentage of {001} facets.

Without wishing to be bound by theory, it is believed that the synthetic method may first form titanium complexes such as TiF₆²⁻ or [TiF₄₋ₓ(OPr)ₓ] (for example, x=2) followed by an olation or oxolation process. The clusters thus formed continue to grow into seeds with a stable structure and well-defined crystallographic facets. Finally the seeds develop into bigger sized SCs and/or larger crystalline structures as a result of anisotropic growth with a longer reaction time.

Again, without wishing to be bound by theory, the solvent, for example 2-propanol, involved in the synthesis is believed to play multiple roles in the formation of anatase TiO₂ crystalline structures: it acts both as a reaction medium and a chelating agent to form alkoxy-substituted Ti^{IV} complexes, which obviously has a different hydrolysis rate, compared with TiF₆²⁻. Also, 2-propanol serves as a protecting agent for crystalline anatase TiO₂ because in acidic conditions, 2-propanol tends to heterolytically dissociate to form an alkoxy group ((CH₃)₂CHO⁻) bound to coordinatively unsaturated Ti⁴⁺ cations on (001) and (101) surfaces. There is a higher density of 5-fold Ti on {001} facets which may lead to more obvious selective adhesion of 2-propanol, which retards the growth along the [001] direction. The optimized profile of isopropoxide species calculated through plane-wave density functional theory indicates their stable state on (001) and (101) surfaces of anatase TiO₂ during synthesis.

Again, without wishing to be bound by theory, as the concentration of fluoride anions, for example the concentration of HF, increases it is observed that smaller particle sizes are formed, and also that the thickness of particles, sheets or structures reduces.

In a further optional aspect, there is provided a method of identifying an optimal absorbate atom (from a group of absorbate atoms) for a specific crystal facet of an inorganic species comprising the steps of:
from the group of absorbate atoms, identifying absorbate atoms with low bonding energy and high bonding affinity for a metal ion of the inorganic species in the specific crystal facets; and
from the absorbate atoms identified in step (a), calculating and comparing the surface energies of the absorbates for the specific crystal facets.

Furthermore, there is provided a method for synthesizing high quality inorganic crystalline material, the method comprising the steps of:
using the method (above) to identify an optimal absorbate atom for a specific crystal facet;
combining a solvent and a source of the absorbate atom with a precursor of the metal; and
subjecting the mixture to hydrolysis.

### BRIEF DESCRIPTION OF FIGURES

Various embodiments/aspects of the invention will be described with reference to the following drawings in which,

FIG. 1 includes theoretical models wherein:
FIGS. 1(a) to 1(d) depict slab models of {001} and {101} facets showing clean and X-terminated surfaces;
FIG. 1(e) depicts the calculated surface energies (y) with different absorbates (X); and
FIG. 1(f) depicts the calculated ratios B/A and S₀₀₁/S with different absorbates (X).

FIG. 2 includes evaluation of the morphology of synthesized products using scanning electron microscopy (SEM) wherein:
FIGS. 2(a) and 2(d) are representative SEM images of the products synthesized with different concentrations of TiF₄ and reaction times;
FIGS. 2(b) and 2(e) depict the statistical analysis of the variations of the length of A and the ratio of B/A (degree of truncation);
FIGS. 2(c) and 2(f) depict the statistical analysis of the variations of the length of A and the ratio of B/A (degree of truncation); and
FIG. 2(g) is an SEM image marked to indicate the interfacial angle between {001} and {101}, the black dashed lines indicating the {001} and {101} crystal planes of anatase TiO₂.

FIG. 3 includes:
FIG. 3(a) is a bright field TEM image of anatase TiO₂;
FIGS. 3(b) and 3(c) are selected-area electron diffraction (SAED) patterns of anatase TiO₂; and
FIG. 3(d) is a corresponding Fast Fourier Transform (FFT) filtered spot diagram of tetragonal atomic arrangement on the (001) surface.

FIG. 4 includes:
FIG. 4(a) which depicts a representative XRD pattern of anatase TiO₂; and
FIG. 4(b) which is an XPS trace depicting the existence and bonding states of the fluoride on the anatase TiO₂ SCs.

FIG. 5 includes plots relating to the size of anatase TiO₂SCs synthesised with a 22 hour reaction time including:
FIG. 5(a) which is plot of comparative numbers of SCs against size (μm); and
FIG. 5(b) which is a plot of comparative numbers of SCs against thickness (μm).

FIG. 6 includes SEM images of anatase TiO₂ SCs synthesised with an 11 hour reaction time including:
FIG. 6(a) which is a low-magnitude SEM image; and
FIG. 6(b) which is a high-magnitude SEM image.

FIGS. 7 to 13 show SEM images of anatase TiO₂ using a TiF₄ precursor and with different precursor concentrations, solvents and volumes of solvent, and HF concentrations.

FIGS. 14 to 18 show SEM images of anatase TiO₂ using a Ti(OBu)₄ precursor and with different precursor concentrations and HF concentrations.

### PREFERRED EMBODIMENTS

Previous experimental and theoretical studies have indicated that absorbate atoms can effectively change the relative stabilities of different crystal facets. (See for example, Chemseddine et al, Eur. J. Inorg. Chem. (1999) 235-245; Jun et al, J. Am. Chem. Soc. 125 (2003) 15981-15985; Chen et al, Chem. Rev. 107 (2007) 2891-2959; Izumi, Bull. Chem. Soc. Jpn. 51 (1978) 1771-1776; Berger et al, J. Cryst. Growth 130 (1993) 108-112.

For anatase TiO₂, among oxygenated surfaces, the (100) surface is the most stable, rather than the (101) surface, in clean and hydrogenated conditions. However, both H- and O-terminated anatase surfaces present high surface energies (y), which restrict the formation of large single-crystal anatase. High y for H- and O-terminated surfaces are mainly caused by the high bonding energies (Dₒ) of H—H (436.0 kJ/mol) and O—O (498.4 kJ/mol)(see Zmbov et al, J. Phys. Chem 71 (1967) 2893-2895). Therefore, to find a low bonding energy (Dₒ) element with high bonding to Ti might be a solution for stabilizing the faceted surfaces.

### Surface Stabilisation Using Fluorine

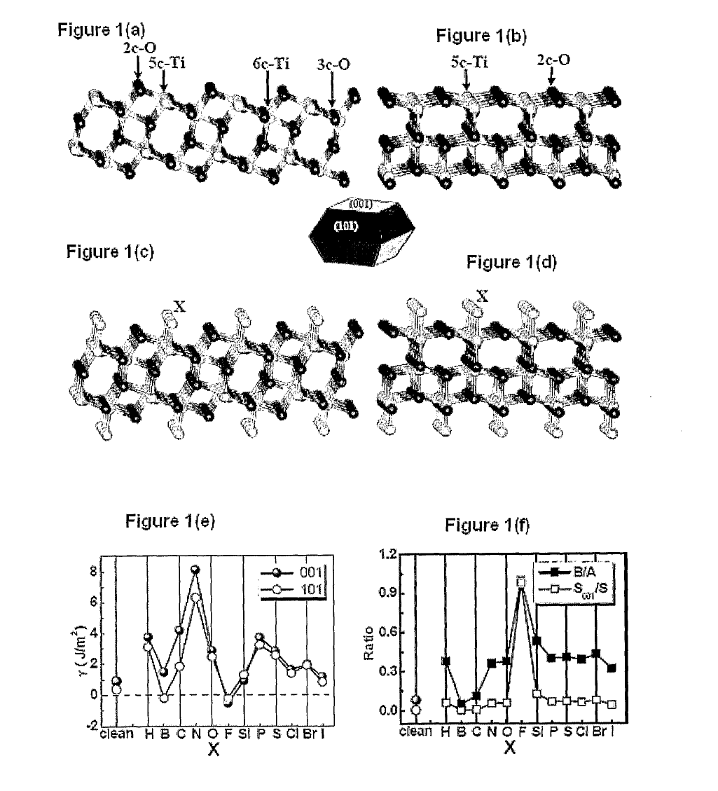

Interestingly, F is such an element as Dₒ^{F13 F}=158.8 kJ/mol and Dₒ^{F—Ti}=569.0 kJ/mol. To further explore whether F is the best element to stabilize the surface, systematic investigation of 12 non-metallic atoms X (X═H, B, C, N, O, F, Si, P, S, Cl, Br, I) was carried out using first-principle quantum chemical calculations, in which clean surfaces of (001) and (101) were used as references. FIG. 1(a) to (d) depicts the slab models of {001} and {101} facets, in which the structures of clean and X-terminated surfaces are shown.

The calculated surface energies (y) with different absorbates are illustrated in FIG. 1(e) (density functional theory (DFT) calculations by using the plane-wave basis Vienna Ab-initio Simulation Package and implementing the generalized gradient approximation of Perdew-Burke-Ernzerhof exchange correlation functional; (see Example 5 for computational details and reliability confirmation)), from which two conclusions can be drawn:
(i) among 12 non-metal-terminated surfaces and the clean surfaces, F-terminated anatase surfaces have the lowest y for both (001) and (101) surfaces, meaning that F-terminated antase surfaces are the most stable; and
(ii) for F-terminated anatase surfaces, the (001) surface is more stable than the (101) surface.

These results indicate that a high percentage of antase {001} facets may be achievable if their surface is surrounded by F. Furthermore, based on the shape dependent thermodynamic model given by Barnard et al (J. Chem. Phys. 121 (2004) 4276-4283), the optimized ratio of B/A (as denoted in the inset of FIG. 1) and the percentage of (001) surfaces can be predicted if the y is known. As shown in FIG. 1(f), the F-terminated surfaces have the highest degree of truncation (approximately B/A→÷1) and, in turn, the F-terminated surfaces of anatase TiO₂ should be dominated by {001} facets.

To verify these theoretical predictions the synthesis described in the Examples was carried out.

### Surface Stabilisation Using 2-Propanol

Based on early X-ray photoelectron spectroscopy (XPS) and temperature programmed desorption (TPD) evidence of Kim et al (J. Mol. Catal. 63 (1990) 103), the O—H bond of 2-propanol can heterolytically dissociate to form an alkoxy group (RO—) with coordinatively unsaturated Ti cation (such as four- or five-fold Ti) on the surface of anatase TiO₂. The prior art has suggested that the chemically adsorbed 2-propanol may not be stable under ambient conditions on anatase TiO₂ surface. Bondarchuk et al (J. Phys. Chem. C, 111 (2007) 11059) has indicated that the adsorbed species may further generate the original alcohol or dehydrogenate/dehydrate to form other products (e.g. alkenes, aldehydes, ketones, water, hydrogen or carbon monoxide). However, based on the density functional theory (DFT) optimisation calculations of Example 3, these reformations or reactions are not found on the (001) or (101) surfaces. Since only half of the Ti atoms on (101) are five-folded, while all of the Ti atoms on (001) are five-folded, the difference may be the main reason that the adding of 2-propanol can adjust the thickness of anatase single crystals.

### EXAMPLES

The present invention will be further described with reference to the following non-limiting examples:

### Example 1

### Synthesis of Anatase Using HF

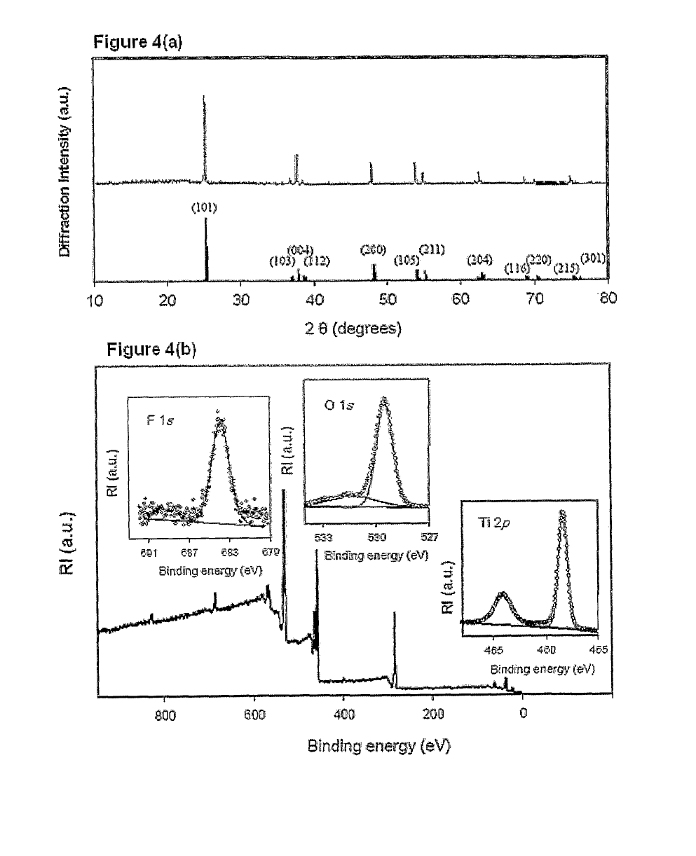

Titanium tetrafluoride (TiF₄, Aldrich) aqueous solution (varying between 2.67 and 533) mM) and hydrofluoric acid (HF, 10% w/w, 0.4 mL in 30 mL of TiF₄ aqueous solution) were used as the antase SCs precursor and the crystallographic controlling agent, respectively, to generate a truncated anatase bipyramidal through a forced hydrolysis process. The reaction was carried out in a Teflon-lined autoclave under 180° C. for 2 to 20 h. The synthesized products are 100% pure anatase phase which is confirmed by X-ray diffraction (XRD) (discussed in FIG. 4a).

### Example 2

### Sample Characterisation

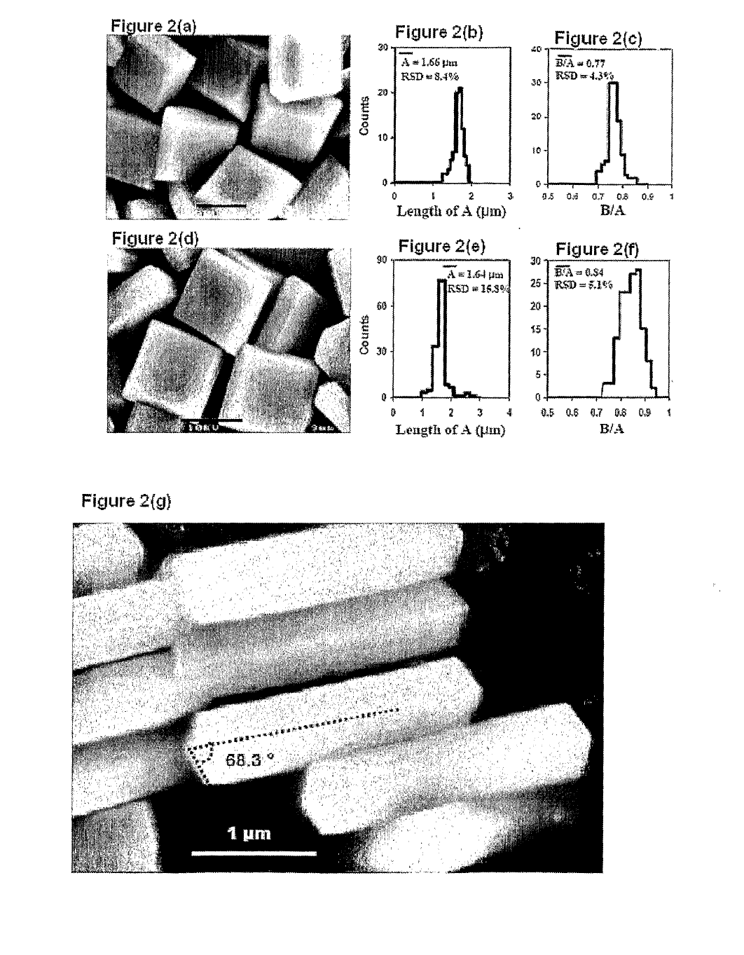

To evaluate the morphology of synthesized products, scanning electron microscopy (SEM) was used. Representative SEM images of the products synthesized with different concentrations of TiF₄ and reaction times are shown in FIGS. 2(a) and 2(d). In both cases, the general morphologies are matched well with the theoretical model shown in FIG. 1(a) to (f), where uniform (shape and size) truncated bipyramidal crystals can be clearly seen. It is of interest to note that (1) large squared flat surfaces have been realized in both cases and (2) the degrees of the truncation are apparently different in both cases.

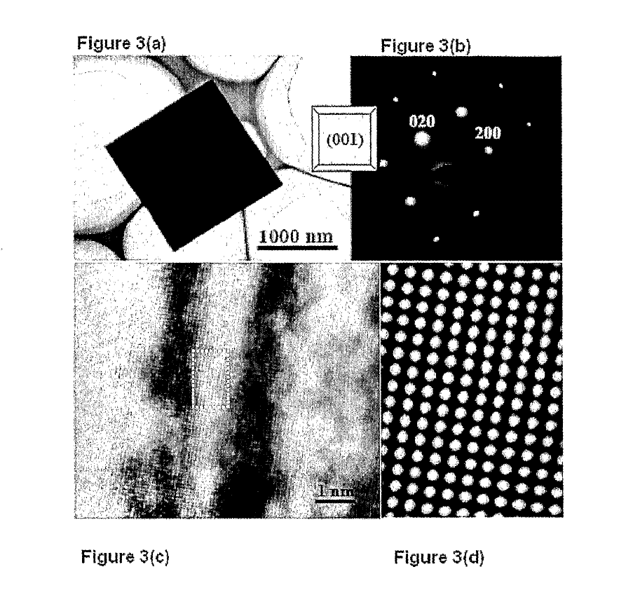

Based on the symmetries of the crystal structure of anatase TiO₂, the two flat squared surfaces must be {001} facets while the other eight isosceles trapezoidal surfaces are {101} facets of anatase SCs (further proved in FIG. 3). The yield of synthesized antase TiO₂ SCs is around 90%, even though some agglomerates and/or irregular particles (FIG. 2(g)) could be occasionally observed.

To examine the uniformity of synthesised anatase crystals, the variations of the length of A and the ratio of B/A were statistically analysed and their results are presented in FIGS. 2(b), 2(c), 2(e), 2(f), respectively. The average lengths are 1.66 μm and 1.64 μm with relative standard deviations (RSDs) of 8.4% and 15.8% (FIGS. 2(b) and 2(e)) for the cases shown in FIGS. 2(a) and 2(d). Their degrees of truncation (assigned as B/A) are 0.77 and 0.84 with RSDs of 4.3% and 5.1% (FIGS. 2(c) and 2(f)), respectively.

The percentages of (001) surfaces can be estimated as 35% and 47% respectively for the two cases, derived from a simple geometric calculation. Thus, crystalline anatase TiO₂ was synthesized having a substantial occurrence of {001} facets.

The anatase SCs with high degree of truncation generated under low concentration of TiF₄ may be explained by the higher fluoride density on the surface and thus make the isotropic growth more obvious; this is remarkably consistent with the previously discussed theoretical predictions, and can be well understood from the viewpoints of shape-control chemistry.

In the absence of HF, no crystal facet control was observed and only hollow spherical polycrystalline anatase particles were formed. Therefore, the HF has possibly played dual roles: it retards the hydrolysis of the titanium precursor as complex forms because it is a product of the reaction, and changes the surface energies to promote isotropic growth along {010} and {100} facets, which is well illustrated in FIG. 1(a) to (f).

In order to investigate the early stages of anatase crystal growth, samples with shorter reaction times were also synthesized. Compared with the sample in FIG. 2(a), the anatase SCs obtained in shorter reaction times show a smaller size and higher degree of truncation than those in FIG. 2(a) (e.g., A=850 nm and B/A=0.84 at 8 h). More importantly, according to the theoretical predictions (FIG. 1(f)), the B/A value can be as high as 1.0 for the fully F-terminated surfaces; this important prediction indicates that ultrathin TiO₂ nanosheets may be generated.

In order to confirm the crystalline phase and to identify the nature of the facets, transmission electron microscopy (TEM) analysis was employed. Bright field images of TEM and selected-area electron diffraction (SAED) patterns confirm that each free standing particle shows single-crystalline characteristics, as reported in FIG. 3(a) to (b). The SAED patterns can be indexed into diffraction spots of the {001} zone, which implies that the anatase SCs are standing on the copper conductive substrate with their {001} axis parallel to the electron beam. The high resolution TEM image recorded from another anatase SCs with the same orientation clearly show the {200} and {020} atomic planes with a lattice spacing of 1.89 Å and 90° interfacial angle. A corresponding Fast Fourier Transform (FFT) filtered spot diagram of tetragonal atomic arrangement on the (001) surface is shown in FIG. 3(d). Furthermore, interfacial angle between two parallel faces and the other surrounding faces is 68.3±0.3° on average; the value is identical to the theoretical value between {001} and {101} facets of anatase.

To confirm the purity of synthesized anatase crystals, XRD was used and the representative pattern is shown in FIG. 4a. All diffraction peaks match well to the crystal structure of the anatase TiO₂ phase (space group: I4₁/amd and lattice parameters: a=3.785 Å, c=9.514 Å, and α=90°). No other diffraction peaks are observed, indicating that the synthesized crystals are of pure anatase phase.

In order to confirm the initial theoretical predictions on the F-terminated surfaces, the existence and bonding states of the fluoride on the anatase SCs were investigated by XPS (illustrated in FIG. 4(b)). XPS spectrum of F 1 s core electrons for the anatase SCs shown in FIG. 2(a) clearly match the model description in FIG. 1(a)-(d); the measured bonding energy (BE) is 684.5 eV only, which is typical value for the fluorinated TiO₂ system such as TiOF₂ or ≡TiF species on TiO₂ crystal surface. The F 1 s peak at a higher BE such as 688.6 eV corresponding to lattice F anions was not detected. Furthermore, the oxidation state of the Ti element in the same materials (Ti 2p_{3/2}, BE=458.8 eV; Ti 2p_{1/2}, BE=464.3 eV) is identical to that of bulk TiO₂ as reported previously.

The insignificant effects of F element on the BE of Ti may be explained by the fact that the overall concentration of F in the samples is relatively low and F elements mainly appear on the surfaces of anatase SCs. As another confirmation, the main peak in O1 s can only be assigned to lattice oxygen atoms of TiO₂, while the small one should be assigned to the common surface hydrated oxygen.

Combining XPS analysis with XRD data in FIG. 4(a), it is apparent that the atomic incorporation or substitution of F for O in anatase TiO₂ crystal lattice (doping process) can be safely ruled out because no significant shift has been found in XRD pattern. Thus the XPS analysis strongly supports the initial theoretical predictions and surface atomic model, that is, the high fluoride-titanium bonding energy lowers the surface energy of the (001) surface dramatically and makes this surface more stable than the (101) surface in the reaction media used.

### Example 3

### Computation of 2-Propanol Characteristics

Calculations based on plane-wave density functional theory (EFT) were used to investigate the geometries of 2-propanol (in a more accurate description, CH₃—CHO—CH₃) on (001) and (101) surfaces of anatase TiO₂. The geometry optimization was then carried out by using the local orbital functional method implemented with the Dmol3 package. All electron calculations with scalar relativistic corrections were applied together with the numerical DN basis set. Exchange and correlation were treated in the generalized gradient approximation (GGA) of Perdew-Burke-Ernzerhof (PBE). Optimisation of atomic positions were performed on alternate cycles using the Broyden-Fletcher-Goldfarb-Shanno (BFGS) method until the convergence criteria were met (maximum energy change per atom=1.0×10⁻⁴ Ha, maximum root-mean-square (RMS) force=0.005 eV Å⁻¹, maximum RMS stress=0.005 Gpa and maximum RMS displacement=5.0×10⁻⁴ Å). The vacuum is more than 15 Å. The k-point set used to sample the reciprocal space was generated using a Monkhurst-Pack grid with 4×4×4 for bulk TiO2, 1×1×1 for slab models due to the sizes of the supercells (4×4).

### Example 4

### Synthesis of Anatase SCs with Different Sizes and Thicknesses

Hydrochloric acid (HCl, 1.5M) was used to adjust the pH of deionized water (1.0 L) to 2.0. Titanium tetrafluoride (TiF₄, Aldrich Chemical) was dissolved in this solution under vigorous stirring to give a concentration of 0.040 M, during which pH was changed to 1.8. The deionized water was used to adjust the concentration. The TiF₄ solution is clear and stable under room temperature. For a typical experiment, 14.5 mL of above TiF₄ solution (2.78 mM), 13.38 mL of 2-propanol (HPLC grade), and 0.5 mL of hydrofluoric acid (HF, 10% w/w) were added into a Teflon-lined stainless steel autoclave. The autoclave was kept at 180° C. for 5.5 to 44 hours in an electric oven. After reactions, the anatase TiO₂ single crystal nanosheets were harvested by centrifugation, washed with deionized water 3 times and then dried in vacuum overnight.

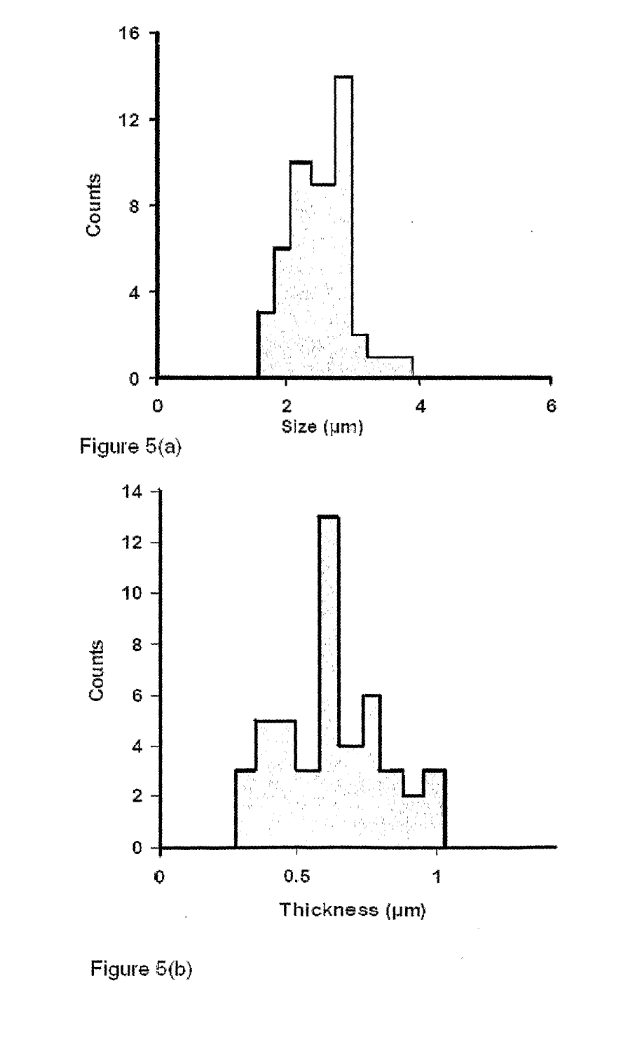

Statistical data showing the size and thickness of the anatase TiO₂ SCs (produced using a reaction time of 22 hours) is included in FIG. 5. The relative standard deviations (RSDs) of the size and thickness are 19.43% and 30.73% respectively.

### Example 5

### Sample Characterisation

The shape, structure, and composition of the resulting samples were investigated by X-ray spectroscopy (XRD, Bruker D8 Advanced Diffractometer, CuKα radiation, 40 kV), scanning electron microscopy (SEM, JEOL JSM6400F), transmission electron microscopy and selected area electron diffraction (TEM/SAED, Philips Tecnai T30F FED Cryo AEM), and X-ray photoelectron spectroscopy (XPS, Kratos Axis ULTRA incorporating a 165 mm hemispherical electron energy analyser). Samples were centrifuged and washed with deionized water twice and then redispersed in water and dropped on a conductive SEM sample holder, or a carbon-coated copper grid with irregular holes for TEM analysis. XPS and XRD sample were prepared by drying the sedimented particles overnight at 100° C.

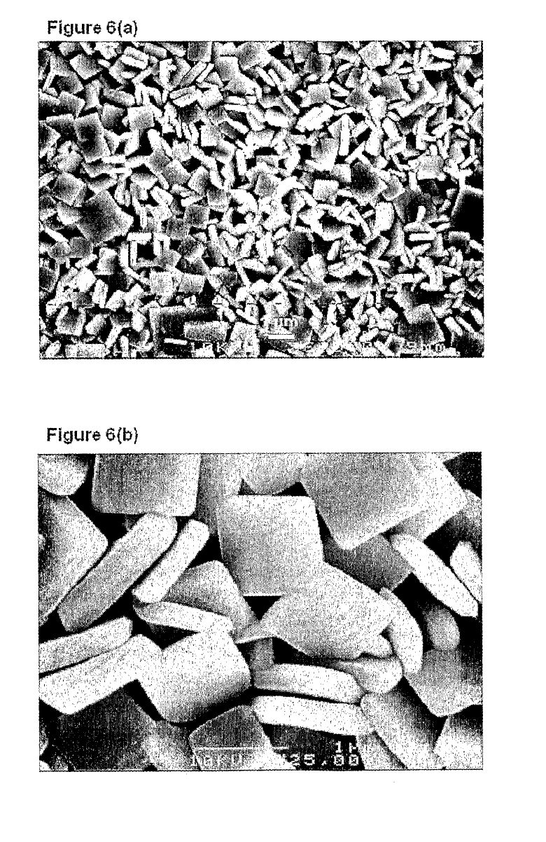

FIG. 6 shows SEM images of anatase TiO₂ SCs synthesised with an 11 hour reaction time. FIG. 6(a) is a low-magnitude SEM image and FIG. 6(b) is a high-magnitude SEM image.

### Example 6

### Synthesis of Anatase Using TiF₄ and HF

A further example of anatase TiO₂ synthesis was carried out using a solvothermal method in an autoclave at 180° C. for 20 hours. Titanium tetrafluoride (TiF₄) was employed as a precursor. 40 ml solvent and 0.4 ml HF were used as reaction reagents. The effect of concentration of HF, amount of precursor and different solvent on the crystalline morphology was investigated using a JSM 6400.

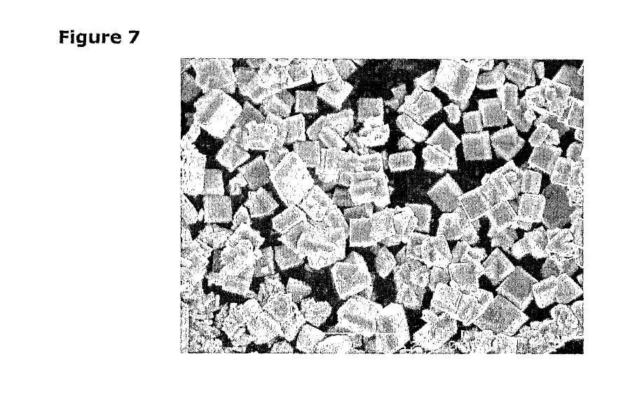

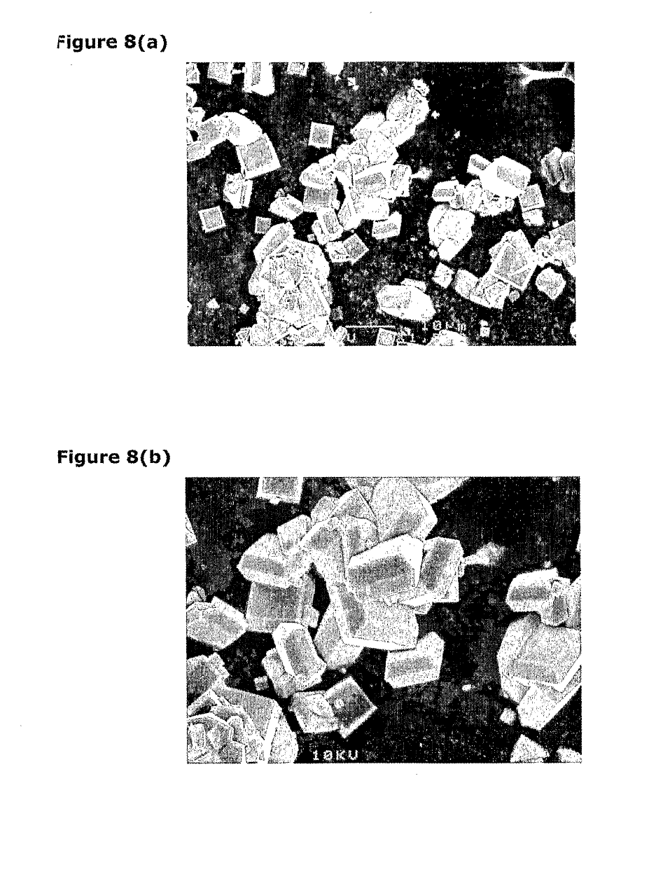

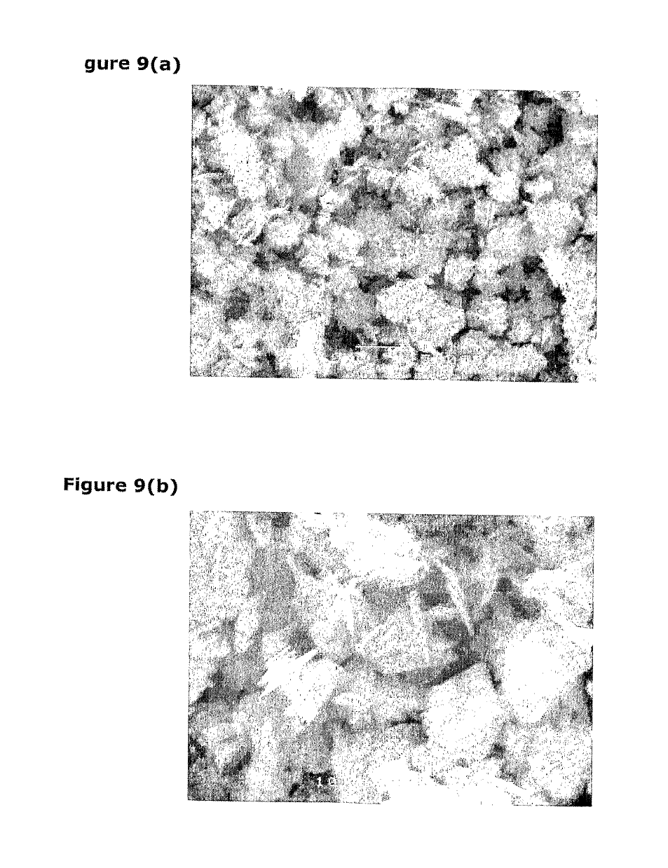

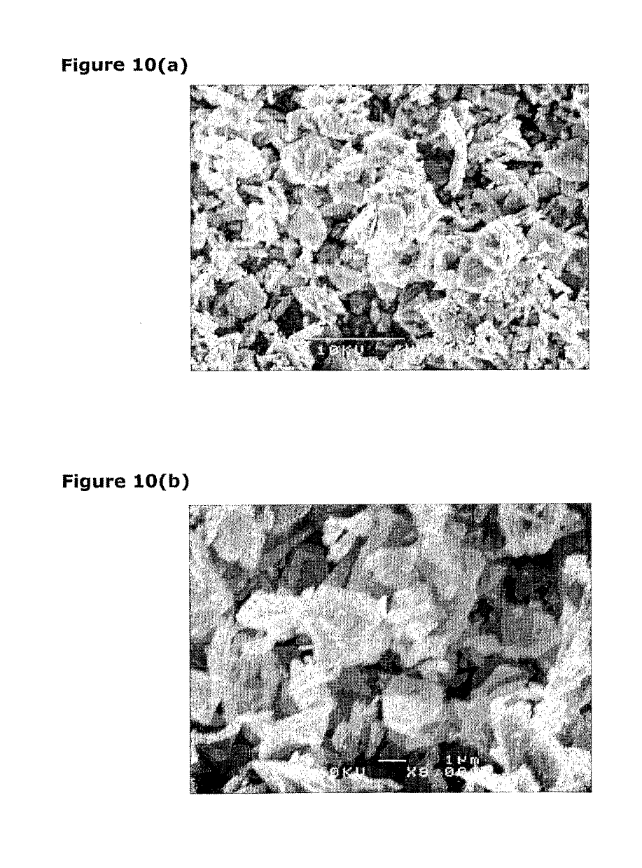

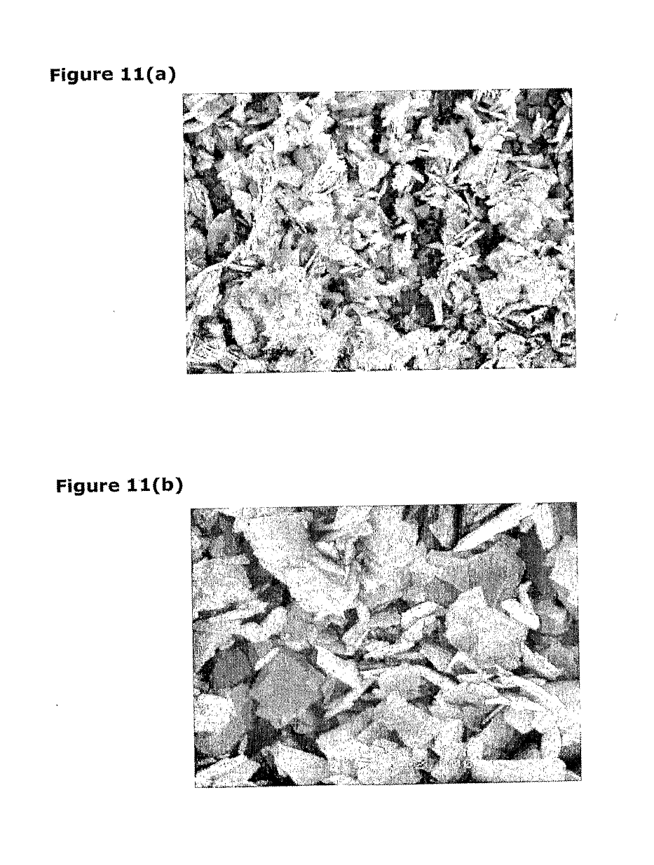

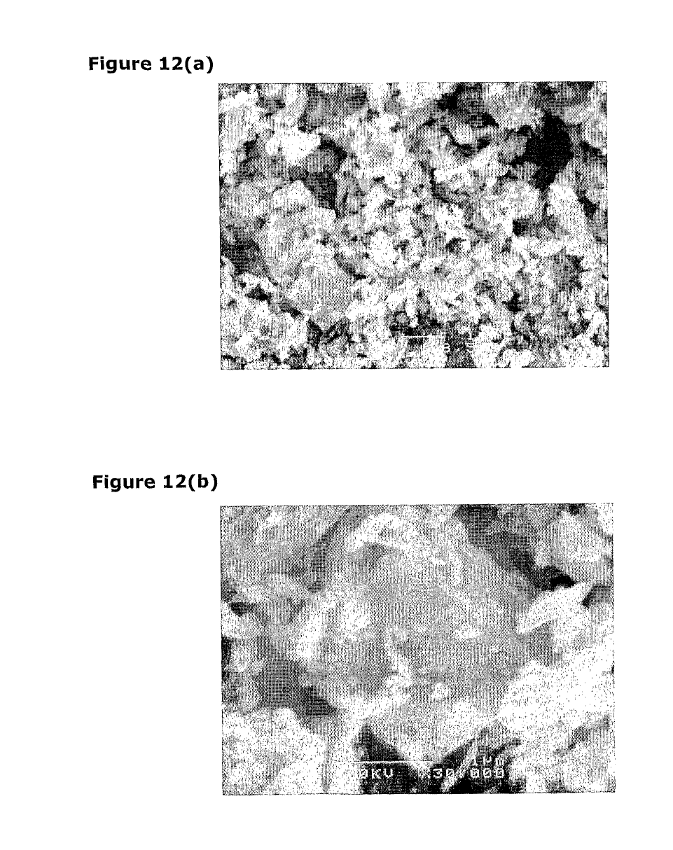

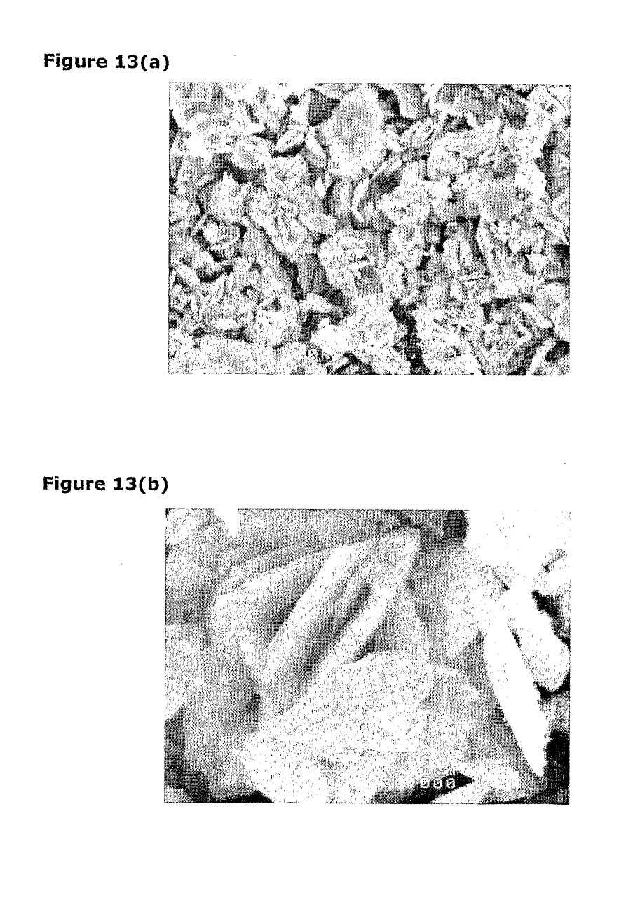

TABLE 1

| | Precursor | | | |
|---|---|---|---|---|
| FIG. | (mmol) | Solvent | Volume (ml) | HF |
| FIG. 7 | 0.16 | water | 40 | 10% |
| FIG. 8 | 0.16 | 1-butanol + | 20 | 10% |
| | | Water | 20 | |
| FIG. 9 | 0.16 | isobutanol | 40 | 10% |
| FIG. 10 | 0.81 | isobutanol | 40 | 20% |
| FIG. 11 | 0.84 | isobutanol | 40 | 30% |
| FIG. 12 | 1.60 | water | 40 | 20% |
| FIG. 13 | 1.60 | isobutanol | 40 | 20% |

Table 1 presents the various amounts of TiF₄ precursor, different solvents, volume of solvent, and HF concentration. The various conditions in each row of the table are indexed to an associated figure showing (a) a low-magnitude SEM image, and where provided, (b) a corresponding high-magnitude SEM image.

FIG. 7 shows truncated anatase TiO₂ bipyramidal SCs are formed. FIG. 8(a) (low-magnitude) and FIG. 8(b) (high-magnitude) again show that truncated anatase TiO₂ bipyramidal SCs are formed, with an approximate crystal size of the order of 10 μm. FIGS. 9(a), 10(a), 11(a), 12(a), 13(a) (low-magnitude) and FIGS. 9(b), 10(b), 11(b), 12(b), 13(b) (high-magnitude) each show that much thinner forms of crystals, crystallites, clusters or aggregates of crystals, or nanosheets, are formed under the conditions used. The {001} facets are believed to be the larger planar areas, which means the more reactive {001} facets are predominant, or at the least substantially occur, compared to other facets, such as the {101} facets, when contrasted or measured by surface area.

It is observed that using TiF₄ as a precursor under relatively high concentration of HF (20˜30%, perhaps 47%), anatase TiO₂ nanosheets having {001} facets (i.e. thin or high aspect ratio anatase TiO₂) can be obtained using isobutanol as a solvent.

### Example 7

### Synthesis of Anatase Using Ti(OBu)₄ and HF

A further example of anatase TiO₂ synthesis was carried out using a solvothermal method in an autoclave at 180° C. for 20 hours. Tetrabutyl titanate (Ti(OBu)₄) was employed as a precursor. 40 ml solvent and 0.4 ml HF were used as reaction reagents. The effect of concentration of HF and amount of precursor on the crystalline morphology was investigated using a JSM 6400.

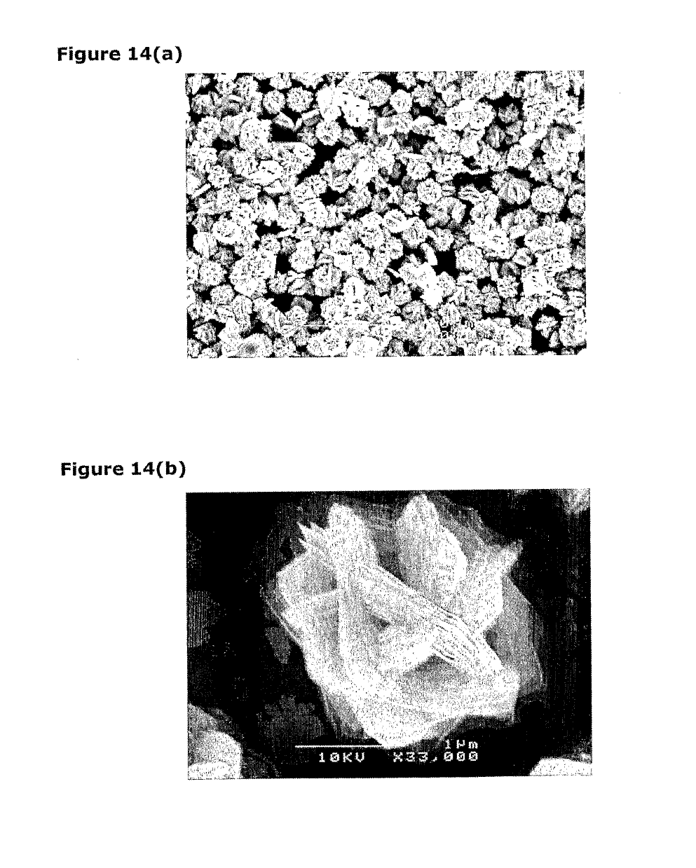

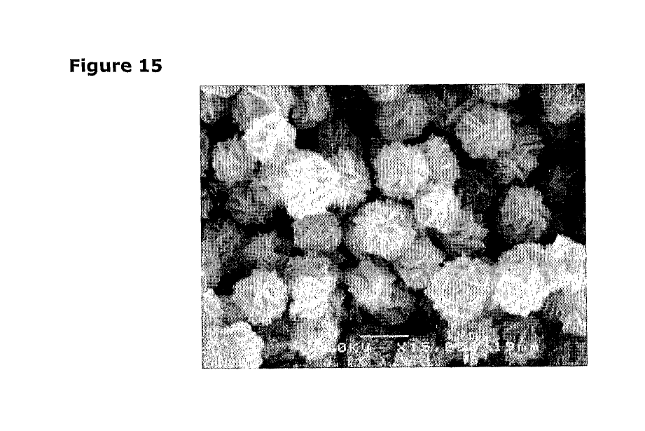

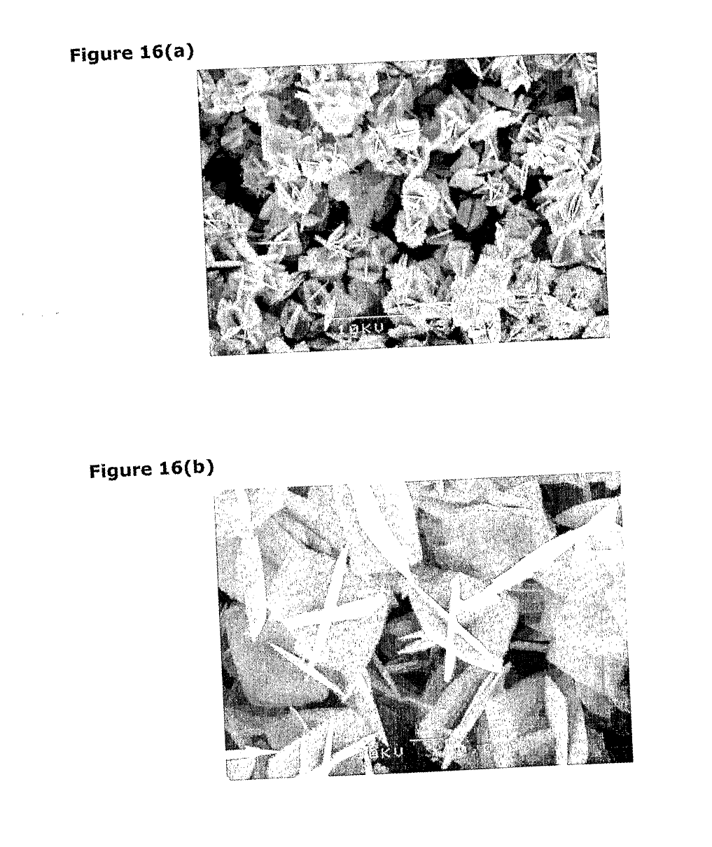

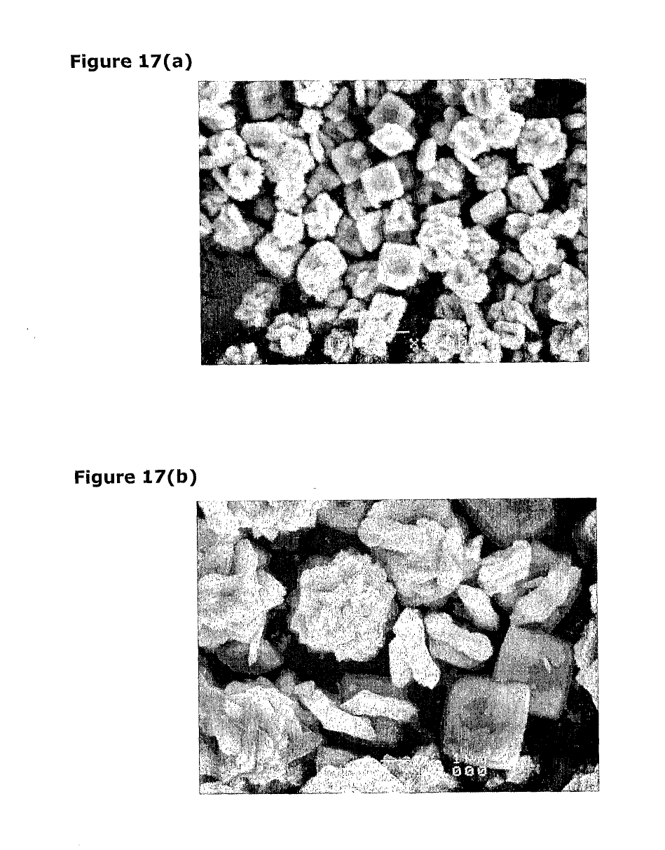

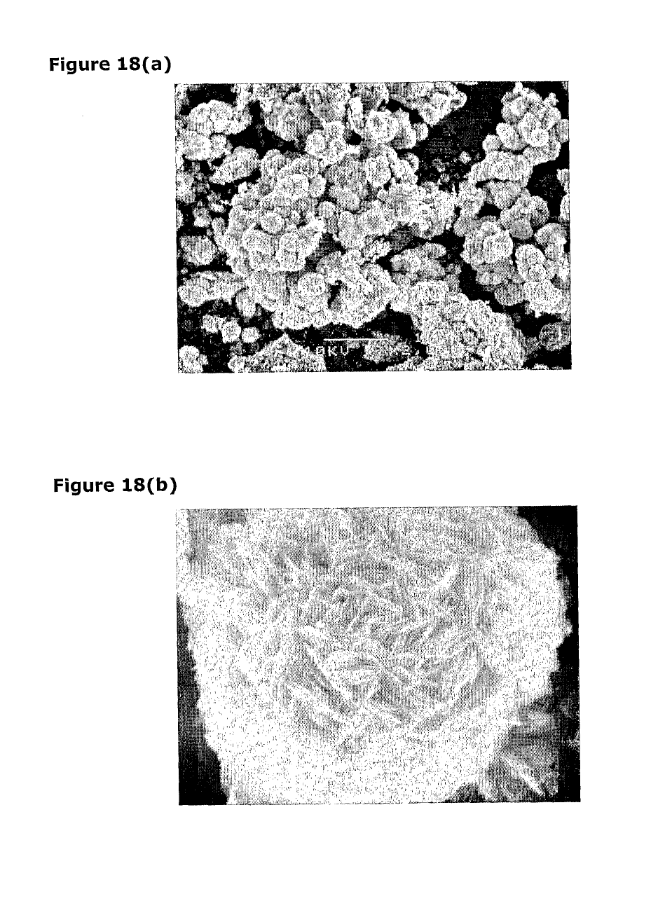

TABLE 2

| | Precursor | | | |
|---|---|---|---|---|
| FIG. | (mmol) | Solvent | Volume (ml) | HF |
| FIG. 14 | 0.36 | isobutanol | 40 | 20% |
| FIG. 15 | 0.46 | isobutanol | 40 | 20% |
| FIG. 16 | 0.46 | isobutanol | 40 | 30% |
| FIG. 17 | 0.65 | isobutanol | 40 | 30% |
| FIG. 18 | 0.82 | isobutanol | 40 | 30% |

Table 2 presents the various amounts of Ti(OBu)₄ precursor, solvent, volume of solvent, and HF concentration. The various conditions in each row of the table are indexed to an associated figure showing (a) a low-magnitude SEM image, and where provided, (b) a corresponding high-magnitude SEM image.

FIGS. 14(a), 15, 16(a), 17(a), 18(a) (low-magnitude) and FIGS. 14(b), 16(b), 17(b), 18(b) (high-magnitude) each show that again much thinner forms of crystals, crystallites, clusters or aggregates of crystals, or nanosheets are formed under the conditions used. The {001} facets are believed to be the larger planar areas, which means the more reactive {001} facets are predominant, or at the least substantially occur, compared to other facets, such as the {101} facets, when contrasted or measured by surface area.

Further, more complex geometric shapes of polycrystalline or paracrystalline structures are observed, for example in FIGS. 14 and 18. It is believed that the crystallites in the more complex structures are substantially formed with {001} facets. FIG. 16 shows a particularly promising crystalline morphology having relatively thin crystals (i.e. nanosheets with a high aspect ratio) with relatively large surface areas provided by the {001} facets, having characteristic lengths of the order of 3-5 μm.

It is observed that using Ti(OBu)₄ as a precursor under relatively high concentration of HF (20˜30%, perhaps 47%), anatase TiO₂ nanosheets having {001} facets (i.e. thin or high aspect ratio anatase TiO₂) can be obtained using isobutanol as a solvent.

As the concentration of fluoride anions, for example the concentration of HF, increases it is observed that smaller particle sizes are formed, and also that the thickness of particles, sheets or structures reduces. In the case of nanosheets, this leads to a larger aspect ratio of length to thickness.

It should also be appreciated that similar or the same solvents as the reaction media (such as an aqueous solution of HF or C5 solvent) could be used to synthesize the same structures of anatase TiO₂.

The word ‘comprising’ and forms of the word ‘comprising’ as used in this description and in the claims does not limit the invention claimed to exclude any variants or additions. Modifications and improvements to the invention will be readily apparent to those skilled in the art. Such modifications and improvements are intended to be within the scope of this invention.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

1. A method for synthesizing crystalline anatase TiO₂ having a substantial occurrence of (001) facets, the method comprising the steps of:
combining a source of fluoride anions with a titanium precursor; and
subjecting the mixture to hydrolysis.

2. The method as claimed in claim 1, wherein the titanium precursor is a titanium salt.

3. The method as claimed in claim 1, wherein the titanium precursor is titanium tetrafluoride (TiF₄).

4. The method as claimed in claim 1, wherein the titanium precursor is tetrabutyl titanate (Ti(OBu)₄).

5. The method as claimed in claim 1, wherein the source of fluoride anions is hydrofluoric acid.

6. The method as claimed in claim 1, wherein the source of fluoride anions is a fluoride salt.

7. The method as claimed in claim 1, further including the step of:
combining a solvent with the source of fluoride anions and the titanium precursor, prior to hydrolysis.

8. The method as claimed in claim 7, wherein the solvent is a polar alcohol.

9. The method as claimed in claim 7, wherein the solvent is selected from the group consisting of n-propanol, ethanol, 1-butanol, isobutanol, water, a solution of an acid, a solution of hydrochloric acid, a solution of hydrofluoric acid, and mixtures thereof.

10. The method as claimed in claim 1, wherein the hydrolysis step is performed by autoclaving.

11. The method as claimed in claim 1, wherein the hydrolysis step is performed at a temperature in the range of about 170° C. to about 220° C.

12. The method as claimed in claim 1, wherein the (001) facets in the synthesized crystalline anatase TiO₂ are predominant, measured by area.

13. Crystalline anatase TiO₂ having a substantial occurrence of predominantly a (001) facets, produced by the method of claim 1.

14. Crystalline anatase TiO₂ having a substantial occurrence of (001) facets, measured by area.

15. The crystalline anatase TiO₂ as claimed in claim 14, wherein the (001) facets are predominant.

16. The crystalline anatase TiO₂ as claimed in claim 14, being of a single crystal structure.

17. The crystalline anatase TiO₂ as claimed in claim 14, being an aggregate or cluster of crystals.

18. The crystalline anatase TiO₂ as claimed in claim 14, being of a polycrystalline or paracrystalline structure, the (001) facets formed in crystallites of the structure.

19. The crystalline anatase TiO₂ as claimed in claim 14, being of a nanosheet structure.
